(19) United States
(12) Patent Application Publication
(10) Pub. No.: US 2005/0231492 A1
(43) Pub. Date: Oct. 20, 2005

(54) Method of signal processing

(75) Inventors: Yuh-Ren Shen, Shih Tong Li (TW); Han-Jon Ho, Kaohsiung (TW); Chang-Cheng Lin, Taipei (TW); Cheng-Jung Chen, Chunan Town (TW)

Correspondence Address: DENNISON, SCHULTZ, DOUGHERTY & MACDONALD;SUITE 105, 1727 KING STREET, ALEXANDRIA, VA, 22314-2700, US

(73) Assignee: VASTVIEW TECHNOLOGY INC.

(21) Appl. No.: 10/965,863

(22) Filed: Mar. 7, 2005

(30) Foreign Application Priority Data
Apr. 16, 2004 (TW) 093110745

(51) Int. Cl. G09G 3/36

(52) U.S. Cl. 345/204

(57) ABSTRACT

A method of signal processing to deal with said gray-scale response speed of brightness of a screen panel by measuring voltage measured values for over driving (called shortly as OD measured values), making tables of the OD measured values, then obtaining four corresponding tables of OD shrunk values from the above tables of the OD measured values by a mode of shrinking, and obtaining OD enlarged values by using a functional operation equation. The method suits a color display device such as an LCD panel; a plasma television set (PDP), a display of a thin film transistor (TFT) or an organic light emitting diode (OLED or PLED).

### BACKGROUND OF THE INVENTION

1. Field of the Invention

The present invention is related to a method of signal processing, and especially to a method of signal processing to deal with gray-scale response speed by measuring voltage measured values for over driving (called shortly as OD measured values), making tables of OD measured values, then obtaining four corresponding tables of OD shrunk values from the above tables of the OD measured values by a mode of shrinking, and obtaining OD enlarged values by using a functional operation equation. The method suits a color display device, such as an LCD panel, a plasma television set (PDP), a display of a thin film transistor (TFT) or an organic light emitting diode (OLED or PLED).

2. Description of the Prior Art

Superiority or inferiority of the performance of an LCD has an index-response time that generally is divided into two kinds: a normally white (NW) mode and a normally black (NB) mode. Wherein the normally white (NW) mode means that a frame is transparent when the LCD panel 10 is not applied with a voltage, in which the frame is a bright frame; while the normally black (NB) mode means that a frame is obscured when the LCD panel 10 is not applied with a voltage, in which the frame is an all-black frame. Taking the normally white (NW) mode as an example, the response time can be divided into two kinds:
(1) ascending response time: the twisting time required for liquid crystal when the brightness of a liquid crystal box of the LCD is changed from 90% to 10% under application of a voltage, this is called in abbreviation as “Tᵣ”; and
(2) descending response time: the time required for the liquid crystal when the brightness of the liquid crystal box of the LCD is changed from 10% to 90% under application of no voltage, this is called in abbreviation as “T_{f}”.

Generally, when the speed of displaying frames is over 25 frames per second, human eyes will take the fast changing frames as continuous sequential pictures; but in modern family amusements, for example, in playing DVD pictures of high quality or in playing games with fast moving frames, the speed of displaying frames normally is above 60 frames persecond; in other words, the frame time interval is 1/60=16.67 ms, if the response time of an LCD is larger than the frame time interval, there will be traces of residual images or skipping to seriously affect the quality of viewing images; as to how to increase the speed of response, it shall be counted on the factor that affects the response time; the followings are respectively the calculation equations for the ascending response time Tᵣ and the descending response time T_{f}:

$$Tr = \frac{{r}_{1} {d}^{2}}{Δ ɛ ( {V}^{2} - {V}_{th}^{2} )} , {T}_{f} = \frac{{r}_{1} {d}^{2}}{Δ ɛ {V}_{th}^{2}}$$

in which r₁ is a coefficient of viscosity of the crystal material; d is a gap of the liquid crystal box; V is a driving voltage of the liquid crystal box; and Δ ε is a dielectric coefficient of the liquid crystal material.

We can see from the above equations that there are four ways to reduce the response time of the LCD: namely, lowering the coefficient of viscosity, reducing the gap of the liquid crystal cell, increasing the driving voltage and increasing the dielectric coefficient. Wherein the technique of increasing the driving voltage is called as the technique of “over drive” with which an integrated circuit driven by the liquid crystal (driver IC) transmits an increased voltage to a liquid crystal panel to increase the twisting voltage of the liquid crystal, thereby the liquid crystal can be faster twisted and recovered to quickly get the brightness desired to be presented of the image data.

In order to practice the above stated technique of “over drive” on R, G and B color-brightness gray scales of 8 bits and 0-255 levels, manufacturers must provide suitable over driving voltage values. However, the R, G and B color-brightness gray scales of 0-255 levels respectively have their desired over driving voltage-values in variation among different time points. Just speaking of the variation of 0-255 levels between two different time points of one color signal, 65,536 different over driving voltage-values can be generated.

If a display screen of an LCD is required to provide over driving voltage-values suitable for the R, G and B color brightness gray scales of 8 bits, the amount of the over driving voltage-values suitable to be stored at least is 65,536; it is clearly that how many memories are required, and the cost of the entire equipment is even more raised. Therefore, manufacturers all present the color-brightness gray scales of 0-255 levels in a mode of simulation with fewer sections; and the brightness of the color signals and the required simulation values of over driving voltages are far less than 65,536.

Although the amount of simulation values of over driving voltages reduces the requirement for memories, however, for the purpose of making the values rapidly and accurately get close to the actual values of over driving voltages, all manufacturers make operations in the mode of simulation with their specific and different functions. They use polynomial functions, bilinear functions or orthogonal functions. But such the mode is limited to the above-mentioned simulation values of over driving voltages, they obtain the values; accordingly, in simulating the actual values of over driving voltages, accuracy often is unable acquired, this not only affects the response time of the liquid crystal screen, but also more affects the effects of their color brightness.

The inventor of the present invention provided a method of signal processing to obtain OD values by functional operation to rapidly and accurately response gray scales of color brightness, in order to get a better effect of increasing the gray-scale response speed.

### SUMMARY OF THE INVENTION

The primary object of the present invention is to provide a method of signal processing to deal with gray-scale response speed of brightness by measuring over driving (OD) measured values, making tables of the OD measured values, then obtaining four corresponding tables of OD shrunk values from the above tables of the OD measured values by a mode of shrinking, and obtaining OD enlarged values by using a functional operation equation. This can save a large amount of hardware resources, and effectively increase the gray-scale response speed of brightness and accurately present the actual gray scales of color brightness.

To achieve the above objects, the method of signal processing of the present invention comprises:
1. Measuring the best OD voltage values in corresponding to all gray scales of brightness in advance:

according to the characteristic of liquid crystals, to find the best OD voltage values desired to be presented of the gray scales of brightness by the mode of practical measuring. Each of the best OD values is related to a corresponding one of the gray scale values presented by a pre-frame and a corresponding one of the gray scale values presented by a proper now-frame, and is related in the mode of one on one. Thereby the measuring can build a table of n×n OD measured values, wherein n is the amount of the gray scales.
2. Building a functional relationship between the OD values and the gray scale values:

simulating the relationship between an OD value and a gray scale value of a pre-frame and a gray scale value of a proper now-frame; if y represents the gray scale value of a pre-frame, x represents the gray scale value of a proper now-frame, the OD value z represents a function of x and y, i.e., z=ƒ(x,y)=C×g(x)×h(y), in which the mathematical function can be a polynomial, a bilinear relationship, a linear combination of orthogonal functions or any type of mathematical function.
3. Shrinking the table of OD measured values and storing it in a look-up table (LUT):

picking the table of n×n OD measured values and to shrink it to form an m×m look-up table, wherein m<n, thereby this can effectively save the space for memories.
4. Making enlarging of the look-up table to get the best OD enlarged values by using the mathematical function having been built:

using the mathematical function having been built and adopting a four-point positioning method, to acquire the best OD enlarged values in a way of curve fitting, and to drive a display with the OD enlarged values.

With the mode of shrinking the OD measured values and acquiring the OD enlarged values by the functional operation in the above steps, dealing with the gray-scale response speed of brightness of a panel of a screen can thus be done.

The present invention will be apparent after reading the detailed description of the preferred embodiment thereof in reference to the accompanying drawings.

### BRIEF DESCRIPTION OF THE DRAWINGS

FIG. 1 is a flow chart of an embodiment of the present invention;

FIG. 2 is a table of OD measured values of the embodiment of the present invention;

FIG. 3 is a look-up table of the embodiment of the present invention; and

FIGS. 4A-D are tables of OD shrunk values of the embodiment of the present invention.

### DETAILED DESCRIPTION OF THE PREFERRED EMBODIMENT

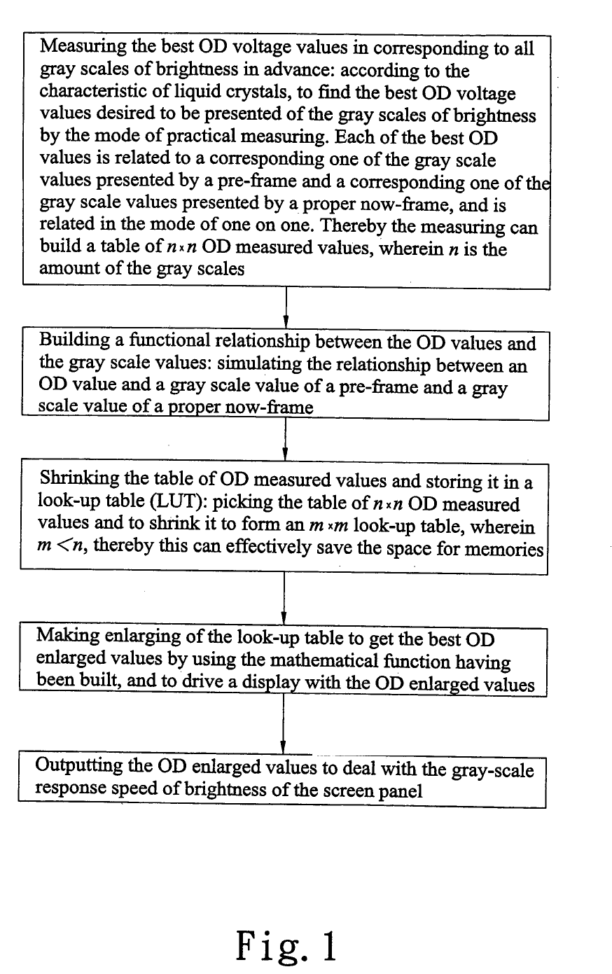

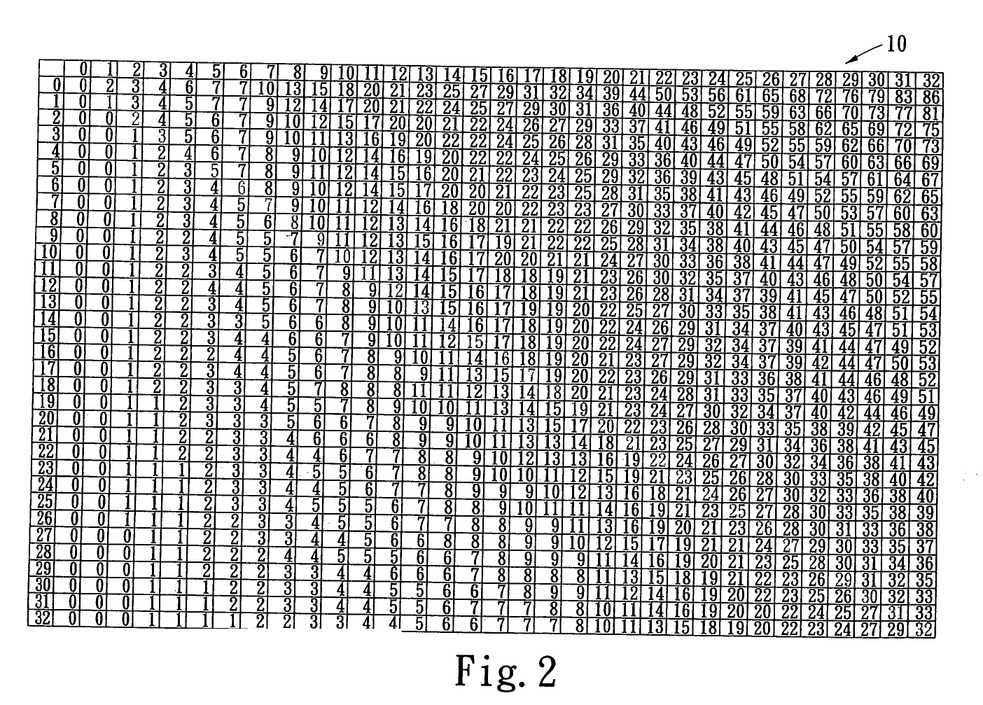

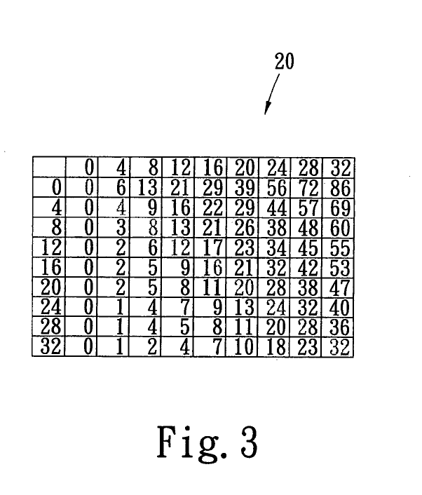

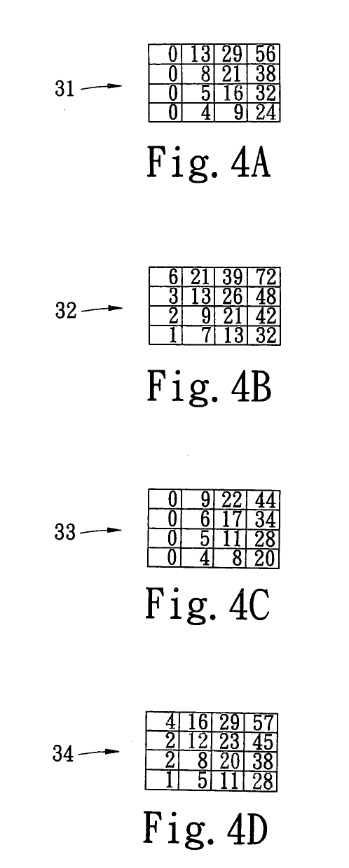

Referring firstly to FIGS. 1-4D showing an embodiment of the present invention for signal processing of gray-scale response speed on a liquid crystal screen, wherein a red-color gray scale of 5-bit signals is taken as an example. It totally has 2⁵=32 output gray-scale values.
1. To measure the best OD voltage values in corresponding to all red-color gray scales of brightness on the liquid crystal screen in advance: according to the characteristic of liquid crystals, to find the best OD voltage values desired to be presented of the gray scales of brightness by the mode of practical measuring; the best OD voltage value is related to the gray scale value presented by a former frame and the gray scale value presented by a present proper frame, they are related in the mode of one on one, thereby the measuring can build an n×n array N, in which n=32 which is the total amount of gray scales; the array N is also called a table 10 of OD measured values. For example, when the gray scale value of the former frame is 16, and the gray scale value of the present proper frame is 26, then the corresponding OD measured value is N_{16, 26}.
2. To build a functional relationship between the OD values and the gray scale values: this step uses functions to simulate the relationship between an OD value and the gray scale value of a pre-frame and the gray scale value of a proper now-frame. If x represents the gray scale value of the proper now-frame, y represents the gray scale value of the former frame, a functional relationship ƒ(x,y) between N_{yx} and x, y can be built. For example, when the gray scale value of the pre-frame is 16, a result ƒ(x, 16)=b×h₁₆(x) can be obtained by simulation according to the measured values N_{16,1}, N_{16,2}, _{. . .} N_{16,31}; or when the gray scale value of the proper now-frame is 26, a result ƒ(26,y)=α×g₂₆(y) can be obtained by simulation according to the measured values N_{1,26}, N_{2,26 . . .} N_{32,26}; thereby, by the value simulation, all the functional relationships between OD values and x, y can be built; namely:
   N_{yx}=ƒ(x,y)=c×h_{y}(x)×gₓ(y)
   wherein C is a normalization constant, while h_{y}(x) and gₓ(y) are mathematical functions, they can be of the type of a polynomial, a bilinear relationship, a linear combination of orthogonal functions or any type of mathematical function.
3. To shrink the table 10 of OD measured values and store it in a look-up table (LUT) 20: to pick the table 10 of OD measured values and to shrink it to form an m×m array M, wherein m<n. A gray scale of 5-bit signals is taken as an example; a table 10 of 32×32 OD measured values is shrunk to form an 8×8 OD look-up table 20. The mode of picking and shrinking can be an equal-space picking method; for example, in the array N, an element is picked from every four elements to form an array M, i.e., Mᵢⱼ=N_{8i-7,8j-7}, wherein i,j=1, 2, . . . m, this indicates the corresponding positions of the matrix elements in the matrix. In practical application, the mode of picking and shrinking is not limited to the equal-space picking method, if it is found in actual measuring that variation rates of some OD values are larger, a non equal-space picking method can be used so long that the relative positions for picking are remembered.
4. To make enlarging of the look-up table 20 to get the best OD enlarged values by using the mathematical function having been built: using the mathematical function having been built and adopting a four-point positioning method, to acquire the best OD enlarged values in a way of curve fitting, and to drive a display with the OD enlarged values. The four-point positioning method adopted in the present invention further severs the OD look-up table 20 into four tables 31-34 of shrunk values. They are respectively P31, Q32, R33 and S34. Wherein the mutually corresponding relationship between the elements in the four tables 31-34 of shrunk values and the elements in the OD look-up table 20 can be expressed as below:

Pₖₗ=M_{2k-1,2l-1}

Qₖₗ=M_{2k,2l-1}

Rₖₗ=M_{2k-1,2l}

Sₖₗ=M_{2k,2l,}

Wererin K,l=1,2, . . . m/2, this indicates the corresponding positions of the elements in the matrix. In other words, in the OD look-up table 20, the four neighboring elements can be expressed by using the corresponding elements of P31, Q32, R33 and S34. Namely:

$$[ \begin{matrix}{M}_{i + j} {M}_{i , j + 1} \\ {M}_{i + 1 , j} {M}_{i + 1 , j + 1}\end{matrix} ] ≡ [ \begin{matrix}{P}_{kl} {R}_{kl} \\ {Q}_{kl} {S}_{kl}\end{matrix} ]$$

in which i,j are odd integers, and k=(i+1)/2, l=(j+1)/2. Thereby, Pₖₗ and Qₖₗ as well as Rₖₗ and Sₖₗ have therebetween respectively the functional relationships of gⱼ(y) and gⱼ₊₁(y) while the Pₖₗ and Rₖₗ as well as Qₖₗ and Sₖₗ have therebetween respectively the functional relationships of hᵢ(x) and hᵢ₊₁(y).

When the gray scale of brightness of a former frame on the liquid crystal screen is y, and the gray scale of brightness desired to be presented of a present frame is x, then Pₖₗ, Qₖₗ, Rₖₗ and Sₖₗ neighboring with (x,y) are found out through the four tables 31-34 of shrunk values, and the best OD enlarged values are obtained by the way of curve fitting or the way of weighted curve fitting according to the corresponding functional relationships of gⱼ(y), gⱼ₊₁(y), hᵢ(x) and hᵢ₊ₗ(y); and the best OD enlarged values activate the liquid crystal screen to make the latter accurately present the desired brightness.

The above stated is only an embodiment for illustrating the present invention, and not for giving any limitation to the scope of the present invention. It will be apparent to those skilled in this art that various modifications or changes without departing from the spirit of this invention shall also fall within the scope of the appended claims.

Therefore, the present invention has the following advantages:
1. It saves hardware resources: a conventional signal processing method for dealing with gray-scale response speed of brightness is performed by functional simulation calculation, while the present invention is to firstly measure the actual OD measured values of a colored display unit, and then to reduce a table by shrinking to form OD shrunk values, the OD shrunk values are stored in a storing element. By virtue that the space of storing required by the table of the OD shrunk values is far smaller than that of the table of OD measured values, it saves a large amount of hardware resources.
2. To “over drive” the gray-scale response speed of brightness: using the OD technique to obtain a specific OD measured value in a mode of functional operation; and thereby to perform the gray-scale response speed of brightness of the colored display unit to effectively accelerate the gray-scale response speed of brightness.
3. To accurately present the gray scales of color brightness: the present invention firstly measures the actual OD measured values of the colored display unit, and then obtains the corresponding OD measured values and functions to obtain the OD enlarged values by performing an enlarging operation, thereby the present invention can accurately present the actual gray scales of color brightness.

In conclusion, according to the description disclosed above, the present invention surely can get the expected objects thereof to provide a method of signal processing to obtain OD enlarged values by using functional operating OD measured values to deal with gray-scale response speed of brightness rapidly and accurately, the method suits various colored display units.

1. A method of signal processing to deal with gray-scale response speed of brightness of a screen panel comprising the steps of:
(1) to measure best OD voltage values in corresponding to all gray scales of brightness in advance: according to the characteristic of liquid crystals, to find best OD voltage values desired to be presented of said gray scales of brightness by a mode of practical measuring; each of said OD values is related to a corresponding one of said gray scale values presented by a pre-frame and a corresponding one of said gray scale values presented by a proper now-frame, and is related in the mode of one on one, thereby a table of n×n OD measured values is built, wherein n is the amount of said gray scales;
(2) to build a functional relationship between said OD values and said gray scale values: to simulate the relationship between each of said OD values and said corresponding one of said gray scale values of said pre-frame and said corresponding one of said gray scale values of said proper now-frame;
(3) to pick some values of said n×n table of OD measured values and to shrink them to form an m×m look-up table, wherein m<n; and
(4) to make enlarging of said look-up table to get best OD enlarged values by using a mathematical function having been built, and to drive a display with said OD enlarged values;
with the mode of shrinking said OD measured values and acquiring said OD enlarged values by said functional operation in said steps (1)-(4), dealing with said gray-scale response speed of brightness of said screen panel is done.

2. The method of signal processing as in claim 1, wherein
said functional relationship is a polynomial, a bilinear relationship or a linear combination of orthogonal functions.

3. The method of signal processing as in claim 1, wherein
said enlarging uses said mathematical function having been built and adopts a four-point positioning method, to acquire said best OD enlarged values in a way of curve fitting.

4. The method of signal processing as in claim 1, wherein
said signal is color signals of red, green and blue (R, G and B).

5. The method of signal processing as in claim 1, wherein
said method is applicable to an LCD panel, a plasma television set (PDP), a display of a thin film transistor (TFT) or a colored display of an organic light emitting diode (OLED or PLED).
